(19) United States
(12) Patent Application Publication
(10) Pub. No.: US 2022/0266264 A1
(43) Pub. Date: Aug. 25, 2022

(54) CENTRIFUGE

(71) Applicant: Andreas Hettich GmbH & Co. KG, Tuttlingen (DE)

(72) Inventors: Matthias HORNEK, Tuttlingen (DE); Andreas HOELDERLE, Braeunlingen-Doeggingen (DE); Albert RUNTZE, Villingen-Schwenningen (DE); Klaus-Guenter EBERLE, Tuttlingen (DE)

(73) Assignee: Andreas Hettich GmbH & Co. KG, Tuttlingen (DE)

(21) Appl. No.: 17/633,982

(22) PCT Filed: Aug. 6, 2020
(86) PCT No.: PCT/EP2020/072200

§ 371 Date: Feb. 9, 2022

(30) Foreign Application Priority Data
Aug. 9, 2019 (DE) 10 2019 121 598.6

(51) Int. Cl. B04B 13/00; H04B 5/02; B04B 9/02; B04B 9/14

(52) U.S. Cl. CPC B04B 13/003; H04B 5/02; B04B 9/02; B04B 9/146; G08B 7/06

(57) ABSTRACT

The invention relates to a centrifuge (10) with a housing (12), in which a rotor (32) for receiving a sample that is to be centrifuged is arranged. The rotor (32) is driven by the drive shaft (22) during operation of the centrifuge (10) and rotates about a rotation axis (30). The rotor (32) has a first, rotor-side transceiver unit, which is excited by an electric field, thus inducing voltage in the first transceiver unit (48). The first transceiver unit (48) is associated with a second, housing-side transceiver unit (62), which is connected to a voltage source. The two transceiver units (48, 62) are connected to a transceiver antenna (52, 64) each, and the transceiver units (48, 62) and the transceiver antennas (62, 64) are in each case arranged on an annular support (46, 60) concentrically with the rotation axis (30).

This patent application is the national phase entry of PCT/EP2020/072200, international application filing date Aug. 6, 2020, which claims the benefit and priority of and to German patent application no. 10 2019 121 598.6, filed Aug. 9, 2019.

PCT/EP2020/072200, international application filing date Aug. 6, 2020 and German patent application no. 10 2019 121 598.6, filed Aug. 9, 2019 are incorporated herein by reference hereto in their entireties.

### BACKGROUND OF THE INVENTION

The invention relates to a centrifuge.

Centrifuging a biological or chemical sample in order to separate the sample components by means of a rotor of a centrifuge usually requires high angular speeds of the rotor. For this purpose, there are also different sample containers and rotors for different samples, which can be used with a basic model of a centrifuge. For this purpose, the rotor is interchangeably connected to a drive shaft of this centrifuge. For a given separation process, a rotor type is selected based on the associated mechanical properties of this specific rotor. The availability of a variety of different rotor types increases the versatility of the centrifuge for use in, among others, biological and chemical experimental research, but also blood banks and medical laboratories.

For each rotor type, there is specific rotor identification information which indicates the type of rotor and its characteristics, for example, a maximum rated speed for safe operation, which generally depends on the maximum permissible stresses and forces caused by centrifugal forces. Operation above the maximum rated speed specified for safe operation of the rotor may result in rotor failure—which will result in major damage. Therefore, it is extremely important that the control system of a centrifuge is able to identify which rotor is currently used and operated by the centrifuge, and that the specified key figures, such as maximum speed and the like, are then maintained during centrifuge operation.

It is equally important that a permissible maximum number of running cycles, i.e. number of starts, is not exceeded, as rotors undergo an aging process due to the high forces acting on the material during running. If the number of running cycles is exceeded, the rotor may break. resulting in the destruction of the centrifuge.

Previously known rotor identification systems mainly rely on magnetic or optical sensors for detecting the rotor identification information. In magnetic systems, magnets are attached to the rotor in specific circular or annular arrangements. These magnets are assigned magnetic sensors provided on the housing, for example Hall sensors. Different numbers of magnets, but also the spacing of the magnets on the rotor, are part of the rotor identification information. The magnetic sensor is used to detect the rotor identification information. Based on the rotor identification information, the control system assigns the maximum permissible speed to the rotor. As a result, the rotor used is always operated at a certain maximum permissible speed. This type of centrifuge is known, for example, from EP 0 604 912 B1.

In addition, the number of starts per rotor code is counted in the control system and the user thus has the possibility to monitor the number of running cycles, which works reliably as long as only one type of rotor always remains in the same centrifuge.

The advantage of such systems is that they have been tried and tested and are robust, and that the magnets provided on the rotor will also withstand many autoclaving processes without damage.

The disadvantage is that the number of codes depends on the number of magnets and is therefore limited. For example, rotors of the same design are always equipped with the same code. If a plurality of identical rotors is used in a single centrifuge or even in a plurality of centrifuges, it is no longer possible to assign the number of cycles to a specific rotor.

Disclosed in DE 10 2004 002 110 A1 is a centrifuge with a housing in which a rotor is arranged for receiving a sample to be centrifuged. The rotor is detachably mounted on a drive shaft, which latter is connected to a drive. During operation of the centrifuge, the rotor is driven by the drive shaft and rotates around an axis of rotation. The rotor has a first, rotor-side transceiver unit with a transceiver antenna in the form of a transponder, which is excited via an electric field, thus inducing voltage in the first transceiver unit. The transponder with the transceiver antenna is arranged to rest flat against the underside of the rotor. The first transceiver unit is associated with a second, housing-side transceiver unit that is connected to a voltage source.

The transponder is a transceiver unit that operates according to the query-response principle. An encrypted query signal received by the transponder is decrypted and evaluated after detection and according to other information from the querying unit. Subsequently, an encrypted response signal selectively intended for the querying unit is automatically generated with the desired information,

This signal is also automatically decrypted and evaluated by the querying unit. All rotor-specific data is stored in the transponder, such data being, for example, year of manufacture, serial number of manufacture, maximum operating radius for the centrifuge, maximum rotational frequency, drive control parameters, temperature compensation values, permissible unbalance values. i.e. permissible acceleration values, etc. Furthermore, it should be possible to continuously store additional data, such as operating hours, running times, number of starts, etc., in the memory of the transponder.

The centrifuge disclosed in DE 10 2004 002 110 A1 has the disadvantage that it is rather unsatisfactory in operation and not suitable for use as series laboratory centrifuges. Reliable data transmission is not ensured because the transponder, i.e. the first transceiver unit, with the transceiver antenna is mounted horizontally on the underside of the rotor so as to rest flat against it, and the second transceiver unit with the transceiver antenna is mounted horizontally on the top side of the drive motor so as to rest flat against it. Both transceiver units are mounted on an annular support concentrically with the axis of rotation, but spaced apart with regard to the height of the axis of rotation. In this arrangement of the transceiver units with transceiver antennas on the rotor and on the drive motor, resp., operation will be adversely affected by metals located behind the first and second transceiver units on the rotor and on the drive motor. Moreover, the various rotor types have different dimensions, so that the spacing of the transceiver antennas varies depending on the rotor type. Due to the different dimensions of the rotor types and a sum of tolerances in the axial direction, it is not possible to arrange the first and second transceiver antennas at a defined distance from one another,

A generic centrifuge is known from JP 2015-20 123 A, which document discloses a centrifuge having a ring-shaped data storage device with an IC chip. The storage device stores information used to identify and manage a rotor of the centrifuge. The IC chip memory is a non-volatile memory which will not lose the data stored in it when the power is turned off, The IC chip is provided with a connection via wiring within the data storage device 42. The information used for identifying and managing the rotor is, for example, the rotor type. the manufacturing number, the number of uses, the cumulative period of use, and the like. Of these, the number of times of use and the cumulative period of use is rewritable data for service life management.

When the rotating shaft 7a rotates (step 102, FIG. 10), for example after the current was turned off due to a power failure or the like during operation, the power will be turned back on in step 101 due to restoration, and it is assumed that the rotor 30 will continue to rotate due to inertia. In this case, the process will therefore wait until rotation of the rotor 30 is stopped in step 102. The term “stop” as used here may for example also relate to a sufficiently slow rotational speed of approx. 1 revolution per second or less, and is not limited to a strictly stationary state. Further, in the present embodiment, the arithmetic unit 14a is configured in such a way that it controls the actuator 70 so that the latter is in the non-energized state (OFF state) when rotation of the rotating shaft 7a is detected.

The arithmetic unit 14a will keep the actuator 70 in the non-energized state (OFF state). When the rotating shaft 7a rotates, and when the rotating shaft la is stopped, the actuator 70 is operated. The actuator is turned on (step 103) in order to move the terminal 50 and the tip 50a into a connection position in which the terminal (electrode) 43 of the adapter 40 makes contact. Accordingly, during rotation of the rotating shaft, 7a, the terminal 50 is retracted to a position in which the terminal (electrode) 43 of the adapter 40 makes contact. In the position in which the terminal 50 does not make contact with the terminal (electrode) 43 of the adapter 40, the terminal 50 and the lever 60 will cause the rotor 30 to rotate. There is no impairment. Then, the arithmetic unit 14a determines whether or not data can be transmitted to, or received from, the data storage device 42 (IC chip 44). This determines whether or not the rotor 30 is attached to the coupling unit 12. Because the terminal (electrode) 43 is of continuous annular shape, as described above, the user can connect the rotor 30 to the coupling part 12 in any position. The terminal 50 and the terminal (electrode) 43 always make contact with each other so that current can be supplied and data can be transmitted and received. Furthermore, if the shape and size of the terminal 50 are appropriately chosen, the terminal (electrode) 43 can have a short discontinuous portion, such as a C-shape.

If it is determined in step 104 that data can be sent to/received from the data storage device 42 (IC chip 44), and the rotor 30 is connected to the coupling unit 12, the arithmetic unit 14a causes the rotor 30 to operate. This means that the data storage device 42 (IC chip 44) reads the data including the identification information for the rotor 30, such as rotor type and serial number, and the usage record including the number of times the rotor has been used and the cumulative period of use (step 107). The mounted rotor 30 is thus specified based on the identification information read (step 108).

Generally disclosed in FR 2 428 821 is a digital signal transmission device for a rotating device that comprises two coils arranged coaxially with respect to each other in close proximity to each other and centered on the axis of rotation of the device. One of the coils is permanently connected to a rotor and the other coil is permanently connected to a stator. One of the coils is supplied with a signal to be transmitted. The other coil serves as the receiver. The radial distance between the coils is within 25% of their diameter. The distance between the coils and the metal masses must be sufficient and is within 25% of the diameter of the coils, but is more than 1% of the diameter of the coils. The coils are embedded in plastic resin or insulating material to avoid magnetic losses. The coils act as transformers to supply electrical power from lie machine to the rotor, without any rotary electrical contact between the stator and the rotor.

WO 2011/054901 discloses a centrifuge in which an RFID chip is arranged in the upper part of the drive shaft so that it occupies a central position on the drive shaft. This RFID chip is a means for storing data relating to the operating history of the rotor mounted on the drive shaft. The lid of the centrifuge has transceiver means that interact with the RFID chip provided on the drive shaft. The transceiver means constitute means for reading (for the receiving part) the data stored on the RFID chip and means for transmitting the data to be stored on the RFID chip. In addition, the transceiver means enable contactless cooperation with the RFID chip for data exchange with it. A program is used for recording:
data relating to the maximum number of cycles,
the conversion of parameters of the centrifugal cycles into data,
the data transmitted to and stored on the RFID chip of the drive shaft.

Moreover, this makes it possible to receive the data stored on the RFID chip, to process such data and compare such data with the data for a maximum number of cycles for a certain rotor so as to prevent a centrifuge cycle from being initiated when the operating history data stored on the RFID chip indicates that this maximum number of cycles has already been reached.

### SUMMARY OF THE INVENTION

Therefore, it is the object of the invention to improve on the design of a centrifuge in such a way that data will be transmitted safely and reliably between the first and second transceiver units regardless of the rotor type. This is to be ensured especially when different types of rotors are used in one centrifuge. In particular, the size and shape of the rotors is not to be changed with respect to the current design.

This object is accomplished by a centrifuge having the characterizing features of claim 1 in combination with the features of its preamble.

The dependent claims relate to advantageous further embodiments of the invention.

The invention is based on the insight that a concentric arrangement of the transceiver antennas, with antennas overlapping in the direction of the axis of rotation, will increase and improve the design options for optimizing data transmission.

According to the invention, the support of the one transceiver unit is smaller in diameter than the support of the other transceiver unit. The transceiver antennas overlap in some regions in the direction parallel to the axis of rotation. This allows the transceiver antennas to always be arranged in the same way relative to one another, irrespective of the design and dimensions of the different types of rotor. As a result, the data transmission quality no longer depends on the rotor type or rotor design on the side facing the drive motor, for example to what extent the bottom of the drive motor is spaced from the top of the drive motor. Moreover, the new arrangement also makes it easy to compensate for tolerances.

Preferably, the transceiver antennas overlap by 50% at least, preferably by 70%, in particular by 90%, preferably by 95%, and particularly preferably by 100%. This further improves the quality of the data transmission between the transceiver units, and the transmission and reception power of the transceiver units can be reduced. Moreover, manufacturing tolerances, especially in the axial direction, will hardly affect the quality of the data transmission anymore.

In an embodiment of the invention, the first support for the first transceiver unit has magnets as identification means for the rotor. In addition, the second support for the second transceiver unit is provided with at least one Hall sensor for detecting the rotor identification code of the first support as provided by the magnets. This thus allows for a redundant transmission of data, for example the rotor identification information.

The transceiver units include temperature-sensitive semiconductors with safety-critical functions which, especially if the permissible temperature is exceeded during autoclaving of the rotor, can be severely stressed and damaged, or at least impaired with regard to their function. Moreover, these parts are also subjected to high centrifugal accelerations. Malfunctions occurring in the prior art transceiver units therefore lead to the rotor being overstressed, with the resulting consequences. For this reason, the speed is additionally monitored by means of the tried and tested so-called tacho coding on the basis of magnets.

To ensure easy assembly, the support is strip-shaped and is inserted into the groove of a support part and fixed in a potting compound.

In each case, the ring-shaped support may comprise a flexible strip-shaped printed circuit board material on which the transceiver unit and the transceiver antenna are mounted. The transceiver unit is preferably molded into the support. Such flexible printed circuit board materials are particularly suitable for mounting electronic components and the lines connecting them thereon.

Preferably, the flexible printed circuit board material comprises polyimide.

As an alternative to a flexible printed circuit board, the antenna and the associated electrical componests with conducting paths can be applied directly to a plastic support component using the MIO (molded interconnect device) process.

In another advantageous embodiment, the printed circuit boards is directly embedded in an injection-molded plastic part by overmolding, which plastic part then forms a protective housing.

The first transceiver unit may have a memory in which the data of the rotor is stored, for example, year of manufacture, serial number of manufacture, maximum centrifugal operating radius, maximum rotational frequency, drive control parameters, temperature compensation values, permissible unbalance values, i.e. permissible acceleration values, etc., in particular the memory comprises both a non-volatile memory and a read-write memory. The non-volatile memory can be used to store all safety-relevant data. The read-write memory can be used to store updates about the rotation cycles run and the rotation conditions prevailing during these cycles.

For example, in order to be able to easily display the rotor identification information but also the other stored rotor data, the second transceiver unit is equipped with an evaluation unit and/or a display unit,

For data transmission, the transceiver units each have a transceiver antenna. The transceiver antenna is preferably arranged in the support in such a way that the transceiver antenna encompasses the support in its peripheral region.

For the purpose of collecting further data from the rotor, additional sensors are provided on the rotor and connected to the transceiver unit. Temperature sensors are for example provided to measure the temperature directly on the rotor and transmit it to a display unit for example, via the transceiver units.

On the motor, to which the second transceiver unit is permanently connected and which has an electrical connection to the control unit, additional sensors may be provided such as acceleration sensors for unbalance detection, which sensors are also connected to the control unit. In an advantageous embodiment, these sensors are also installed on the printed circuit board of the second transceiver unit.

In an embodiment of the invention, the first transceiver unit comprises a transponder, and the second transceiver unit comprises an associated reader.

These transceiver units can be based on the NFC standard, which has proven useful in particular for the interference-free transmission of data over short distances.

The difference in the radii of the first support and the second support is in the range of between 0.3 mm and 8 mm. On the one hand, the aim here is to keep the distance between the supports as small as possible to guarantee optimum data transmission, and on the other hand to mount the supports with the electrical components units in a protected manner and to protect them from mechanical damage.

Preferably, the first and/or second support each equipped with the transceiver unit and transceiver antenna is enclosed in a protective housing. This allows the transceiver units and the transceiver antennas to be arranged within the protective housing in a protected manner. This thus protects both the transceiver units and the transceiver antennas against mechanical damage.

The protective housing can be designed as an annular chamber which is U-shaped in section. The U-shaped opening of the protective housing for the first support can be directed upwards. in particular in the direction parallel to the axis of rotation, towards the rotor, and connected to the rotor on this side. In a protective housing for the second support, the U-shaped opening of the protective housing can be directed downwards, in particular in the direction parallel to the axis of rotation, towards the motor housing, and connected to the motor housing on this side.

The first and/or the second support may be bonded to the protective housing to securely attach it to the rotor or the motor. The complete protective housings are then connected to the rotor and the motor using screws, for example. The bonding can be done with a potting compound, such as a casting resin, which completely encloses the support, thus embedding it in a waterproof manner. Autoclaving is then possible without any problem.

In an embodiment of the invention, a set of different rotors is provided for a centrifuge which can be driven by it.

In this case, each first transceiver unit of the rotors can also be located at the same height relative to the axis of rotation, thus ensuring a uniform transmission quality.

It may be advantageous for each rotor to have a cylindrical projection extending downward towards the drive motor, which projection is arranged concentrically with respect to the axis of rotation of the drive shaft, The distance between a rotor seat on which the rotor sits on the drive shaft, and the free end of the projection is the same in each case. This provides for a way to arrange the transceiver units at the same height relative to the axis of rotation.

In a further aspect, the invention relates to a method for operating a centrifuge of the type set forth above. In this case, a first set of data from the first transceiver unit is acquired during operation by the second transceiver unit; preferably simultaneously, a second set of data about the magnets of the first support can be acquired by a sensor of the second support. The first and second data sets are then compared. If the first and second data sets match, operation of the centrifuge will continue.

In particular, if the first and second data sets do not match, the centrifuge will be switched off.

In addition or alternatively, a visual and/or acoustic alarm may be triggered if the first and second data sets do not match.

In an embodiment of the invention, the rotor identification information is read from both the first transceiver unit and from the magnets of the first support. The rotor identification information read is assigned corresponding maximum speeds of the centrifuge which will not be exceeded during operation.

Additional advantages, features and possible applications of the present invention may be noted from the following description in which reference is made to the embodiments illustrated in the drawings.

Throughout the description, claims and drawings, those terms and associated reference signs are used as are stated in the list of reference signs below.

### BRIEF DESCRIPTION OF THE DRAWINGS

In the drawings,

FIG. 1 is a perspective top view of a centrifuge according to the invention, taken at an angle from above;

FIG. 2 is a sectional ew along a longitudinal central axis of the centrifuge of FIG. 1;

FIG. 3 is an enlarged view of a centrifuge detail marked X in FIG. 2;

FIG. 4 is another enlarged view of a centrifuge detail marked Y in FIG. 3;

FIG. 5 is a view of a strip-shaped support with an antenna, and a first transceiver unit;

FIG. 6 is a view illustrating the support of FIG. 5 closed to form a ring;

FIG. 7a is a perspective top view of the first transceiver unit with the protective housing, taken at an angle from above;

FIG. 7b is an exploded view of the first transceiver unit of FIG. 1a;

FIG. 8 is a view of a strip-shaped support with an antenna, a sero t nsceiver unit with a Hall sensor and an accelerometer;

FIG. 9 is a view illustrating the support of Fig losed to form a ring, and

FIG. 10 is a schematic diagram of the supports in section.

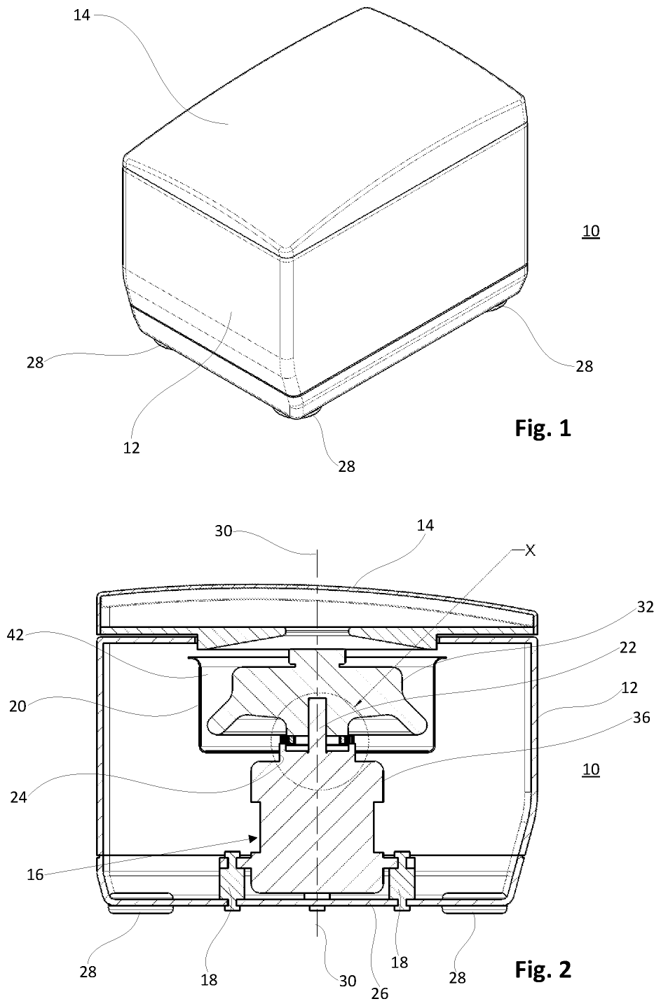

### DESCRIPTION OF THE INVENTION

The figures illustrate an embodiment of a centrifuge 10 according to the invention. The centrifuge 10 includes a housing 12 and a lid 14 closing the housing 12 at the top. Inside the housing 12, a drive motor 16 is firmly connected to the housing 12 via damping means 18. A protective vessel 20 is attached to the housing 12. For the sake of simplicity, the fasteners are not shown in the drawing. The protective vessel 20 is arranged concentrically relative to a drive shaft 22. The protective vessel 20 has a concentric circular recess 24 made therein for the passage of a portion of the drive motor 16 therethrough.

The housing 12 is provided with four feet 28 that are disposed in the area of a bottom 26 of the housing 12, where they are arranged in corner areas of the bottom 26 of the substantially rectangular shaped centrifuge 10.

The drive shaft 22 of the drive motor 16 is adapted to be rotated about an axis of rotation 30 and is concentric thereto.

Arranged concentric to the axis of rotation 30 and thus also to the drive shaft 22, a rotor 32 is provided which sits on the drive shaft 22. The rotor 32 can be easily exchanged for another rotor 32 via a quick-release fastener not shown in detail here. The centrifuge 10 can be operated by means of a set of rotors 32 which are designed differently for different applications for centrifuging different types of samples and sample containers.

Each rotor 32 has a plurality of receptacles far sample containers, not shown in detail here for the sake of clarity.

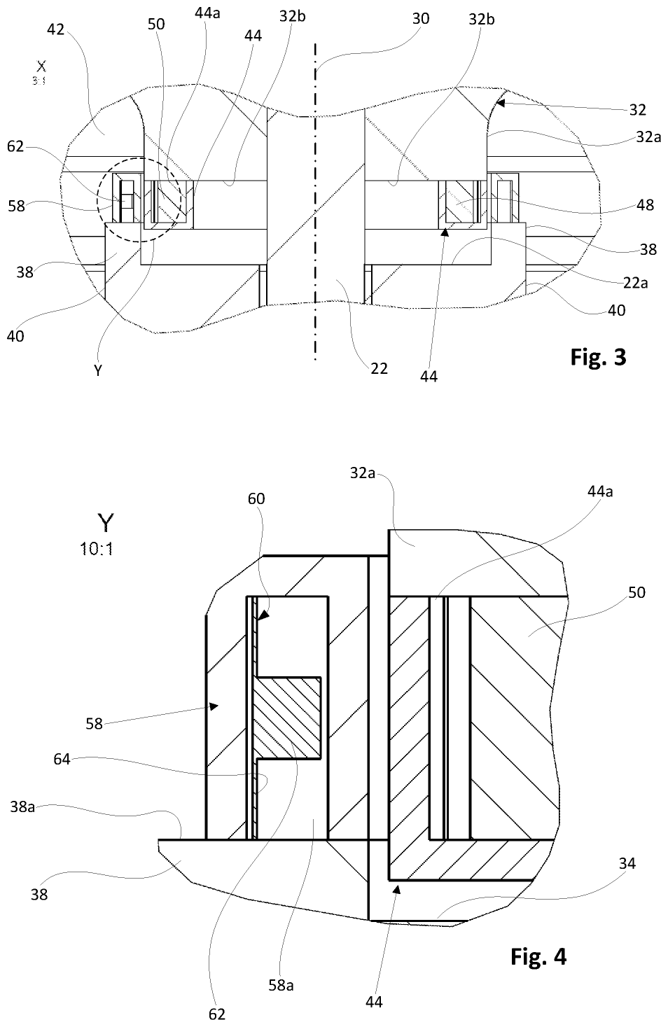

FIG. 3 is an enlarged view of a detail marked X in FIG. 2, and FIG. 4 is an enlarged view of a detai marked Y in FIG. 3.

The lower portion of the rotor 32 has a peg-shaped cylindrical projection 32a that includes the drive shaft 22. After the rotor 32 has been mounted on the drive shaft 22 and firmly fixed in position, the peg-shaped projection 32a is located at a distance from a shoulder 34 on the top of the drive motor 16. The drive shaft 22 extends from a motor housing 36 of the drive motor 16 beyond the shoulder 34, which is part of the motor housing 36, through the peg-shaped projection 32a of the rotor 32 and further into the rotor 32. The shoulder 34 is part of a motor housing 36 of the drive motor 16 and thus part of the stationary portion of the drive motor 16, whereas the drive shaft 22 is part of the portion of the drive motor 16 that rotates about the axis of rotation 30.

The shoulder 34 of the motor housing 36 is provided with an annular shoulder 38 that extends upwards from the shoulder 34 and delimits the shoulder 34 laterally. The shoulder 34 is part of a cylindrical projection 40 of the motor housing 36 extending toward the rotor 32. Both the annular shoulder 38 and the shoulder 34 are part of a bearing shield associated with the drive motor 16.

The drive motor 16 is substantially of a rotationally symmetrical design, and is arranged concentrically to the axis of rotation 30. The projection 40 extends through the protective vessel 20 into a rotor chamber 42 bounded by the protective vessel 20 and the lid 14. Below the protective vessel 20, the remainder of the motor housing 36 extends nearly to the bottom 26 of the housing 12 of the centrifuge 10.

Adjoining the underside 32b of the projection 32a of the rotor 32 is a plastic annular chamber 44 of U-shaped cross-section, whose U-shaped opening 44a faces in the direction of the underside 32b of the projection 32a of the rotor 32, is arranged concentrically to the axis of rotation 30 and is connected, preferably screwed, to the underside 32b of the projection 32a of the rotor 32 via the end faces of the legs of the U-shaped opening 44a. In this way, the annular chamber 44 is firmly secured to the rotor 32 and is thus entrained in rotation during operation of the rotor 32. The cylindrical projection 32a is the same in all the different rotors 32 and thus rotor types, in particular the diameter and the distance between the underside of the projection 32a and the shoulder 34 as well as the distance between the underside of the projection 32a and the seat (not shown here) of the rotor 32 on the drive shaft 22 are the same.

The underside of the annular chamber 44 faces toward the substantially horizontally extending shoulder 22a of the projection 40 of the motor housing 36. There is sufficient clearance between the top of the shoulder 22a and the underside of the annular chamber 44 to prevent contact between the parts.

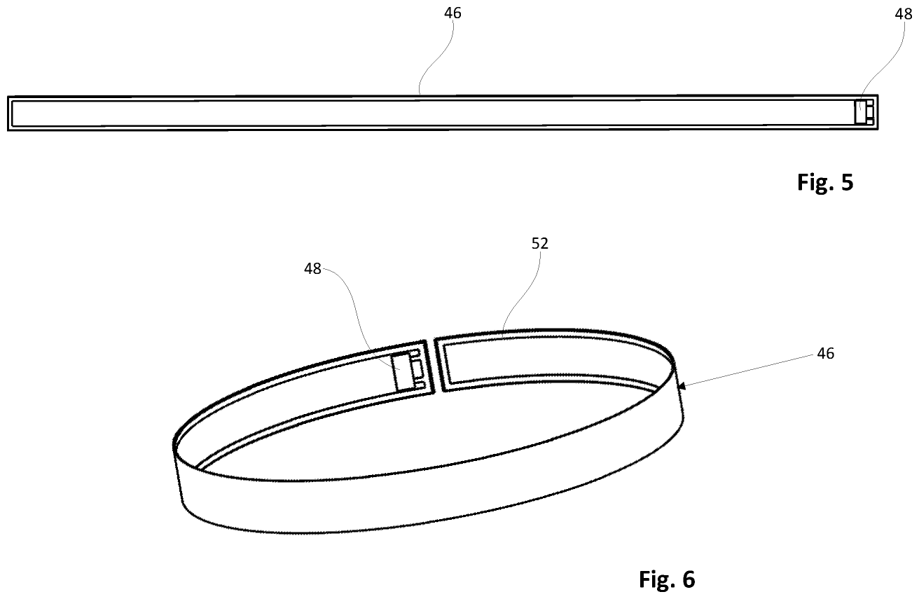

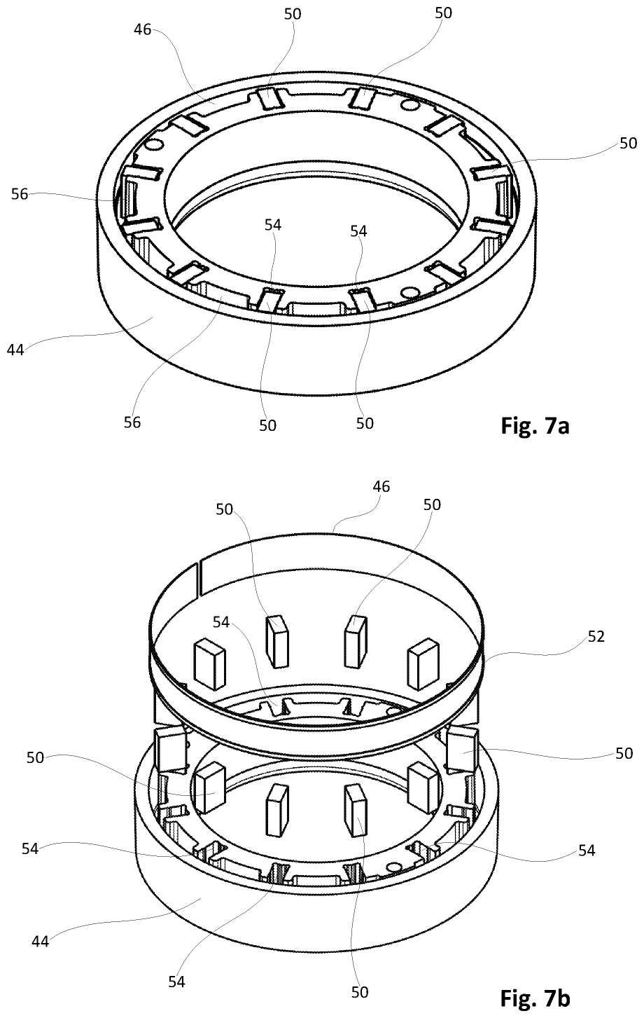

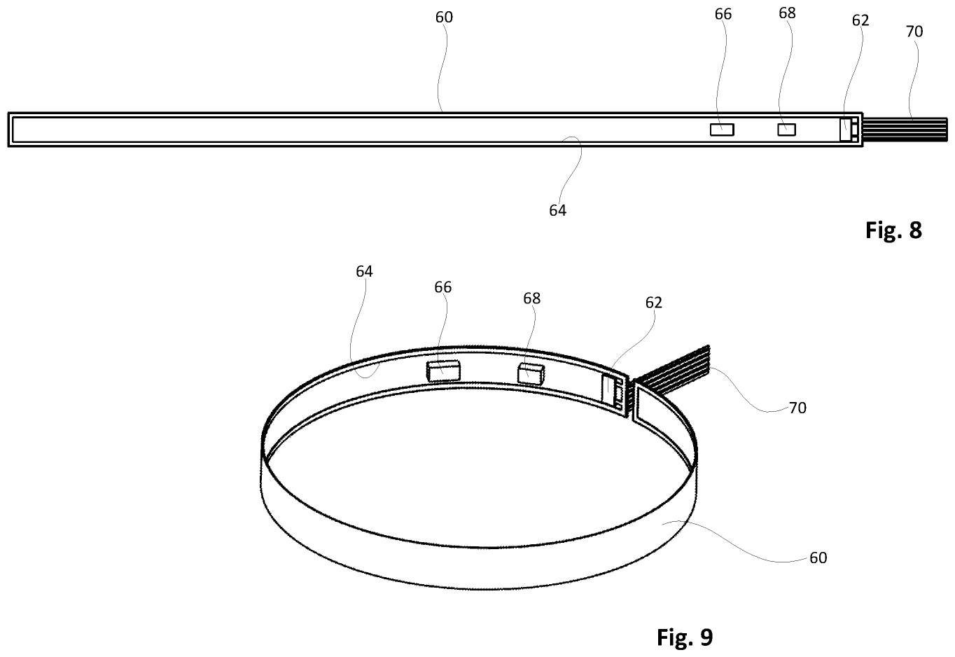

A strip-shaped support 46 is bonded to the inside of a leg of the annular chamber 44, which leg is U-shaped in cross-section. The support 46 is made of a flexible, film-like circuit board material, namely polyimide. Arranged on one side of the support 46 is a first transceiver unit 48 and several magnets 50 are arranged at a distance from it. The transceiver unit 48 is connected to a transceiver antenna 52 which surrounds the support 46 in the peripheral region on its outer side, see FIGS. 5 and 6, but also FIGS. 7a and 7b.

A receptacle 54 is associated with each magnet 50. Between the support 46 and the magnets 50 in the respective associated receptacle 54, a cavity 56 is provided which is filled with potting compound after assembly. The potting compound used can be epoxy resin, for example.

The support 46 is formed as a strip element. In FIG. 5, the support 46 is rolled out flat, and in FIG. 6, the support 46 is shown in an annular configuration, i.e. the shape it assumes when inserted into the support.

A second annular chamber 58 (dip ring) is also provided on the annular shoulder 38, which chamber is U-shaped in cross-section. Its U-shaped opening 58a faces in the direction of the top 38a of the annular shoulder 38 of the projection 40 of the motor housing 36. The annular shoulder 38 is concentric with the rotation axis 30 and is connected to the top 38a of the annular shoulder 38 of the projection 40 of the motor housing 36 via the end faces of the legs of the U-shaped opening 58a. In this way, the annular chamber 58 is firmly secured to the motor housing 36 and will thus also remain stationary during operation of the centrifuge 10.

A strip-shaped support 60 is bonded to the inside of a leg of the annular chamber 58, which leg is U-shaped in cross-section. The support 60 is made of a flexible, film-like circuit board material, namely polyimide. Arranged on one side of the support 60 is a second transceiver unit 62 and a Hall sensor 66. The second transceiver unit 62 is connected to a transceiver antenna 64 that surrounds the support 60 in the peripheral region. In this respect, the support 60 is of a similar design as the support 46.

The support 60 is likewise formed as a strip element and has an electrical connection line 70 at its free end, which line leads to the control unit.

The annular chambers 44 and 58 each form protective chambers for the supports 46, 60 accommodated therein, so as to protect them against mechanical damage, for example. in particular, the annular chamber 44 is important because it acts to protect the electrical components of the support 46 during autoclaving.

The second transceiver unit 62 is connected to a control unit (not shown in detail here) with an external unit for the centrifuge 10 and a display unit connected thereto.

The annular chamber 58 is arranged radially outwardly relative to the annular chamber 44 with respect to the axis of rotation 30. The distance between the annular chambers 44, 58 is in a range of between 0.3 mm and 8 mm. The two transceiver antennas 52, 64 are positioned at the same height with respect to the axis of rotation 30 and thus overlap by 100%. This ensures optimum data transmission between the transceiver antennas 52, 64 and thus between the transceiver units 48, 62.

The rotor identification information is also part of the data transmitted.

Moreover, the Hall sensor 66 of the second support 60 and the magnets 50 of the first support 46 are arranged at the same height with respect to the axis of rotation 30 and thus overlap by 100%. In a known manner, the rotor identification information is transmitted which is constituted by the number of magnets and the way they are arranged.

Because the rotor identification information and the related data are safety-relevant data, this embodiment provides for them to be transmitted redundantly to a control device of the centrifuge 10 from the rotor-side support 46 to the housing-side support 60, i.e. on the one hand by the magnets 50 which are detected by the Hall sensor 66, but also by the transceiver units 48 and 62.

In addition, the operating data, such as running cycles, running times, etc. is stored for rotor identification both in a memory of the control device of the centrifuge 10 as well as in a memory of the transceiver unit 48.

For this purpose, the first transceiver unit comprises a memory in which the data of the rotor is stored, for example rotor type, maximum permissible rotational speed, maximum permissible running time of the rotor and the like. This data is stored in a non-volatile memory. Moreover, a read-write memory is provided in which operating data, such as runtime cycles, operating time, driving speeds and the like, is continuously updated.

Furthermore, an accelerometer 68 is provided on the second support 60. The accelerometer 68 is used to detect potential imbalances, and the control device can react to them if necessary, for example when predefined threshold values are exceeded.

The first transceiver unit 48 may comprise a transponder and the second transceiver unit 62 may comprise an associated reader.

The transceiver units 49, 62 are designed for the NFC standard.

During operation of the centrifuge 10, before centrifugation is started, the rotor identification information is read from the first transceiver unit and, during startup at the latest, the rotor identification information is additionally detected via the magnets 50. These data sets are compared with each other in the process, If the data or the identification information match, operation of the centrifuge 10 will continue based on the operating data associated with the rotor identification information, maximum permissible speed, maximum service life, maximum load change, etc.

If there is no data match in the rotor identification information, the centrifuge will be switched off, and visual and acoustic alarms will be triggered.

If data is detected via the acceleration sensor 68 that exceeds a predetermined threshold, the centrifuge 10 will also be switched off and a visual alarm, such as an error message on a display, and an acoustic alarm will be triggered.

The invention is characterized by the fact that a minimum distance between the transceiver antennas 52, 64 can be created at which tolerances have hardly any adverse effect. The overlapping arrangement of the transceiver antennas 52, 64 makes data transmission insensitive to possible tolerances in the axial direction, i.e., the position of the rotor 32 relative to the drive motor 16. In addition, as a result of the coaxial opposite arrangement of the supports 46, 60 on the cylindrical projection 32a of the rotor 32, which projection has the smallest possible radius, or on the projection 40 of the motor housing 36, which projection has the smallest possible radius, the centripetal force acting on the transceiver unit 48 can be minimized.

The invention is furthermore characterized by the fact that there is no metal directly behind the supports that would prevent the buildup of a magnetic field.

Using the NFC standard is a cost-effective and secure way of transmitting data. The redundancy in the transmission of the motor identification information significantly increases the safety of the centrifuge 10 during operation, Maximum speeds that are too high can thus be avoided in an easy and reliable manner.

Arranging the annular support 46 at the same height as the different rotors 32 results in the same data transmission quality for all rotors 32.

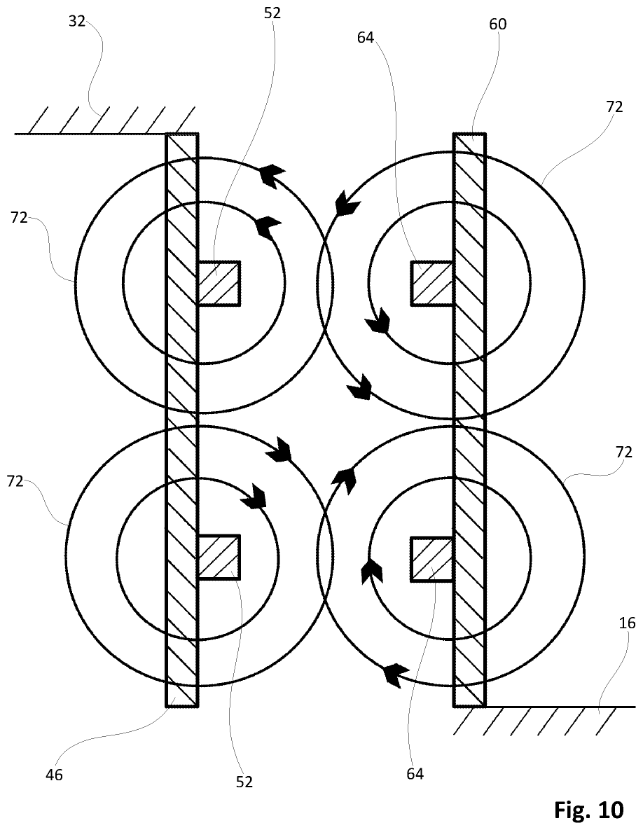

The arrangement, according to the invention, of the supports 46 and 60 in the direction of the axis of rotation 30 results in optimized data transmission because the rotor 32, which is usually made of metal, and the drive motor 16, which is likewise made of metal, will not interfere with the field lines of the transceiver units 48, 62. This is schematically illustrated in FIG. 10, in which the field lines are designated by reference sign 72. In this arrangement, no metal is in the immediate vicinity of the supports 46, 60, thus allowing for the magnetic field or the electromagnetic field to build up easily and without interference.

### LIST OF REFERENCE SIGNS

10 centrifuge
12 housing
14 lid
16 drive motor
18 damping means
20 protective vessel
22 drive shaft
22a shoulder of projection 40 of motor housing 36
24 concentric circular recess of protective vessel 20
26 bottom of housing 12
28 feet of housing 12
30 axis of rotation
32 rotor
32a projection of the rotor 32
32b underside of projection 32a of rotor 32
34 shoulder of drive motor 16
36 motor housing
38 annular shoulder
38a top of annular shoulder 38
40 projection of motor housing 36
42 rotor chamber
44 first annular chamber—rotor side
44a U-shaped opening of annular chamber
46 first support
48 first transceiver unit
50 magnet,
52 transceiver antenna of first transceiver unit 48
54 receptacle for magnets 50 in the first annular chamber 44
56 cavity in the first annular chamber 44
58 second annular chamber—housing side
58a U-shaped opening of annular chamber 58
60 second support
62 second transceiver unit
64 transceiver antenna of second transceiver unit 62
66 Hall sensor
68 accelerometer
70 connection line
72 field lines

1-28. (canceled)

29. Centrifuge (10), comprising:
a housing (12), in which a rotor (32) is arranged for receiving a sample that is to be centrifuged, which rotor (32) sits detachably on a drive shaft, which is connected to a drive, which rotor (32) is driven by the drive shaft (22) during operation of the centrifuge (10) and rotates about a rotation axis (30), which rotor (32) has a first, rotor-side transceiver unit, which is excited by an electric field, thus inducing voltage in the first transceiver unit (48), the first transceiver unit (48) is associated with a second, housing-side transceiver unit (62), which is connected to a voltage source, the two transceiver units (48, 62) are connected to a transceiver antenna (52, 64) each, and the transceiver units (48, 62) and the transceiver antennas (52, 64) are in each case arranged on an annular support (46, 60) concentrically with the rotation axis (30), characterized m that the support (46) of one transceiver unit (48) has a smaller diameter than the support (60) of the other transceiver unit (62), and the transceiver antenna (52) of one transceiver unit (48) overlaps in part with the transceiver antenna (64) of the other transceiver unit. (62) in a direction parallel to the rotation axis (30).

30. Centrifuge as claimed in claim 29, characterized in that the bottom surface of one or both sup-ports does not rest against metal.

31. Centrifuge as claimed in claim 29, characterized in that the transceiver antennas (52, 64) overlap by 50% in the direction parallel to the axis of rotation (30), preferably by 70%, in particular by 90%, preferably by 95%, and particularly preferably by 100%.

32. Centrifuge as claimed in claim 29, characterized in that the rotor (32) comprises both a first support (46) for the first transceiver unit (48) and magnets (50) as identifiers for the rotor (32),

33. Centrifuge as claimed in claim 29, characterized in that the second support (60) for the second transceiver unit (62) comprises at least one Hall sensor (66) for determining the rotoridentification information of the first support (46) as specified by the magnets (50).

34. Centrifuge as claimed in claim 29, characterized in that the support (46, 60) is strip-shaped.

35. Centrifuge as claimed in claim 29, characterized in that each annular support (46, 60) comprises a flexible strip-shaped circuit board material on which the transceiver unit (48, 62) and the transceiver antenna (52, 64) are mounted.

36. Centrifuge as claimed in claim 35, characterized in that the flexible circuit board material comprises polyimide.

37. Centrifuge as claimed in claim 29, characterized in that the first transceiver unit (48) has a memory in which the data of the rotor (32) is stored, for example the type of rotor, the maximum rotational speed of the rotor, the maximum running time of the rotor, in particular the memory comprises both a non-volatile memory and a read-write memory.

38. Centrifuge as claimed in claim 29, characterized in that the second transceiver unit (62) is connected to an evaluation unit and/or to a display unit.

39. Centrifuge as claimed in claim 29, characterized in that the transceiver antenna (52, 64) in each case substantially comprises the annular support (46, 60) in the peripheral region

40. Centrifuge as claimed in claim 29, characterized in that the first support (46) is used to transmit further data from sensors located on the rotor (32),

41. Centrifuge as claimed in claim 29, characterized in that the first transceiver unit (48 comprises a transponder and the second transceiver unit (62) comprises an associated reader.

42. Centrifuge as claimed in claim 41, characterized in that the transceiver units (48, 62) are based on the NFC standard.

43. Centrifuge as claimed in claim 29, characterized in that the difference in radii of the first support (46) and the second support (60) is in a range of between 0.3 mm and 8 mm.

44. Centrifuge as claimed in claim 29, characterized in that the support (46) of the first transceiver unit (48) and/or the support (60) of the second transceiver unit (62) with transceiver antenna (52, 64) is surrounded by a protective housing.

45. Centrifuge as claimed in claim 44, characterized in that the protective housing (12) is formed as an annular chamber (44) which is U-shaped (44a) in section.

46. Centrifuge as claimed in claim 45. characterized in that the U-shaped opening of the protective housing (12) for the first support (46) is directed upward, in particular in a direction parallel to the rotation axis (30), towards the rotor (32), and is connected to the rotor (32) on this side.

47. Centrifuge as claimed in claim 45, characterized in that the U-shaped opening of the protective housing (12) for the second support (60) is directed downwards, in particular in a direction parallel to the rotation axis (30), towards the motor housing (36) and is connected to the motor housing (36) on this side.

48. Centrifuge as claimed in claim 44, characterized in that the support (46, 60) is bonded to the protective housing (12).

49. Centrifuge as claimed in claim 29, characterized in that a set of different rotors (32) is provided.

50. Centrifuge as claimed in claim 49, characterized in that each first transceiver antenna (52) of the rotors (32) is arranged at the same height relative to the rotation axis (30).

51. Centrifuge as claimed in claim 49, characterized in that each rotor (32) has a cylindrical projection (32a) facing downwardly onto the drive motor and arranged concentrically to the rotation axis (30) of the drive shaft (22), with the distance between a rotor seat on which the rotor (32) sits on the drive shaft (22), and the free end of the projection (32a) being the same in each case.

52. Method of operating a centrifuge (10) as claimed in claim 29, characterized in that
a first set of data of the first transceiver unit (48) is read during operation by the second transceiver unit (62),
a second set of data is acquired by a sensor of the second support (60) via the magnets (50) of the first support (46),
the first and second sets of data are compared,
if the first and second sets of data match, operation of the centrifuge (10) will continue.

53. Method as claimed in claim 52, characterized in that, if the first and second data sets do not match, the centrifuge (10) will be switched off.

54. Method as claimed in claim 52, characterized in that, if the first and second sets of data do not match, a visual and/or an acoustic alarm will be triggered.

55. Method as claimed in claim 52, characterized in that rotor: identification information is read from both the first transceiver unit (48) and the magnets (50) of the first sup-port (46) maximum speeds corresponding to the rotor identification information. read are assigned to the centrifuge (10), which speeds are not exceeded during operation.

56. Method as claimed in claim 52, characterized in that, when a predetermined threshold value is exceeded with respect to the data provided by the acceleration sensor (68), the centrifuge (10) will be switched off.
